(19) United States
(12) Patent Application Publication
(10) Pub. No.: US 2019/0009740 A1
(43) Pub. Date: Jan. 10, 2019

(54) TEMPORARY POWER MANAGEMENT FOR A TELEMATICS CONTROL UNIT

(71) Applicants: Harold R. Macks, Van Buren Township, MI (US); Thomas P. Moyles, JR., Van Buren Township, MI (US)

(72) Inventors: Harold R. Macks, Van Buren Township, MI (US); Thomas P. Moyles, JR., Van Buren Township, MI (US)

(21) Appl. No.: 15/643,065

(22) Filed: Jul. 6, 2017

(51) Int. Cl. B60R 16/033; H02J 9/06; H04B 1/3822

(52) U.S. Cl. CPC B60R 16/033; H04B 1/3822; H02J 9/061

(57) ABSTRACT

Methods, systems, and circuits are provided that allow temporary power management of a telematics control unit (TCU). Employing the aspects disclosed herein, a TCU may handle temporary losses of power from a main battery of a vehicle, without overly drawing power from a backup battery (BUB) system. The aspects disclosed herein may be implemented through the addition of circuit elements as well as logic changes to existing TCU systems.

### BACKGROUND

Vehicles are traditionally provided with an electrical power source to power the electronic components, referred to as automotive battery. An automotive battery is a rechargeable battery that supplies electrical energy to a motor vehicle. These batteries are also called starting-lighting-ignition (SLI) batteries. If the vehicle is in an operation of running, the power for the car may be supplied via an alternator.

Vehicle's may be provided with certain emergency functions. One such function is the emergency call (ecall) system. Ecall systems automatically allow a vehicle's telematic system (telematic control unit (TCU)) to call an emergency service provider/first responder, such as the police or fire department.

Thus, if the vehicle is in an accident, the ecall systems automatically instigates a call to one of the predefined dispatch services. The ecall system sends a control signal to the TCU, and subsequently, the TCU uses a built-in telephony system to contact the designated emergency contact.

Because the emergency dictating the need to employ an ecall system may also render use of the automotive battery as either not possible or unsafe, ecall systems are provided with backup battery power to serve any power needs when access to the battery is denied or limited.

However, power interruptions are common in vehicle applications. For example, the wiring harness may temporarily create an open circuit, or large draws of power from other vehicle systems may temporarily render the main power source as unavailable.

FIG. 1 illustrates a prior art implementation of power management for a TCU 100. As shown, the TCU 100 is electrically coupled to the battery 110 and a backup battery (BUB) 120. The battery 110, during normal vehicle operations, is configured to be the main supplier of power to the TCU 100.

When the battery 110 is detected as not connected, the BUB 120 supplies power. However, as noted above, several situations cause the BUB 120 to erroneously be relied upon. For example, bumps in the road may cause the battery 110 to be temporarily disconnected. In other situations, large loads attached to the battery 110 may also create inadequate supplies to the TCU 100.

In those situations, the BUB 120 is then relied upon to supply power to the TCU 100. However, due to the conditions listed above, the BUB 120 may be relied upon excessively, with this reliance resulting in an excess power drawn from the BUB 120, thereby ensuring that the BUB 120 is at a power level that is incapable of providing power during an ecall scenario.

### SUMMARY

The following description relates to system, methods, and circuits related to power management for an emergency call (Ecall) system in a vehicle. Exemplary embodiments may also be directed to any of the system, the method, or an application provided and incorporated into a vehicle-based electronic implementation.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates a prior art implementation of a system from providing backup power for a TCU.

FIGS. 2(a) and (b) illustrate a system for providing temporary power management for a TCU.

FIG. 3 illustrates a flowchart of a method for providing the logic for the microcontroller of FIG. 2.

FIG. 4 illustrates an example graph of the waveforms generated with the systems shown in FIGS. 2(a) and (b).

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Vehicle electronics are commonly being incorporated with a telematics control unit (TCU). The vehicle TCU allows communication to external parties, through employment of any electronic-based communication techniques known.

The TCU may be implemented with ecall technology. Ecall technology automatically notifies an interested party (for example, a first responder) in situations where a detected crash occurs.

Existing TCU systems are implemented with back-up batteries (BUB). The BUB provides a finite amount of voltage/energy to supply to the TCU system in situations where the main battery is no longer able to supply power. However, because existing vehicle electronic systems experience false disconnections with the main battery, the BUB is often relied upon and power is drawn. This leads to situations where the BUB is depleted, and essentially, not usable during real emergency situations.

Disclosed herein are systems, methods, and electronic circuits provided for a temporary management of power for a telematics control unit. Thus, by employing the aspects disclosed herein, a vehicle's electronic system may handle temporary losses of power without depleting a backup battery system.

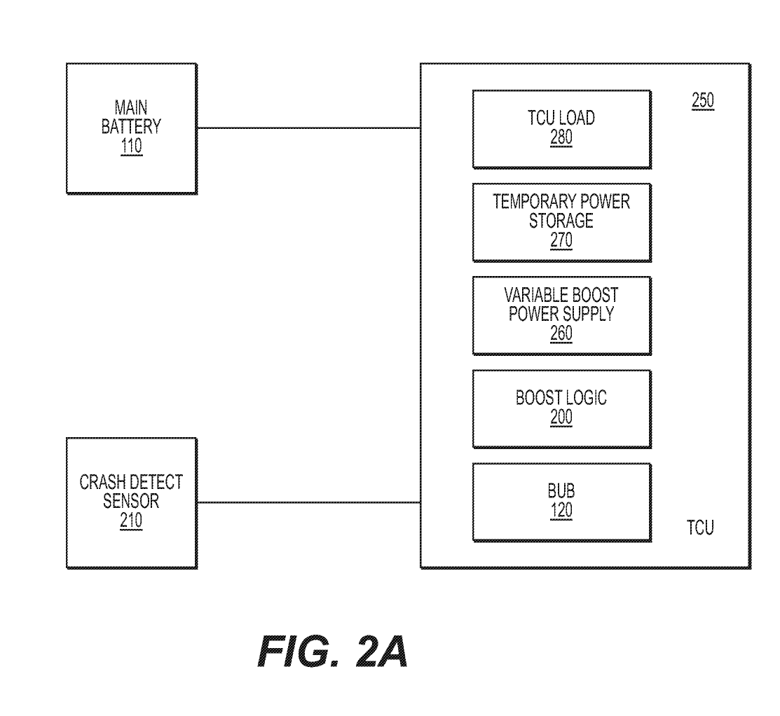

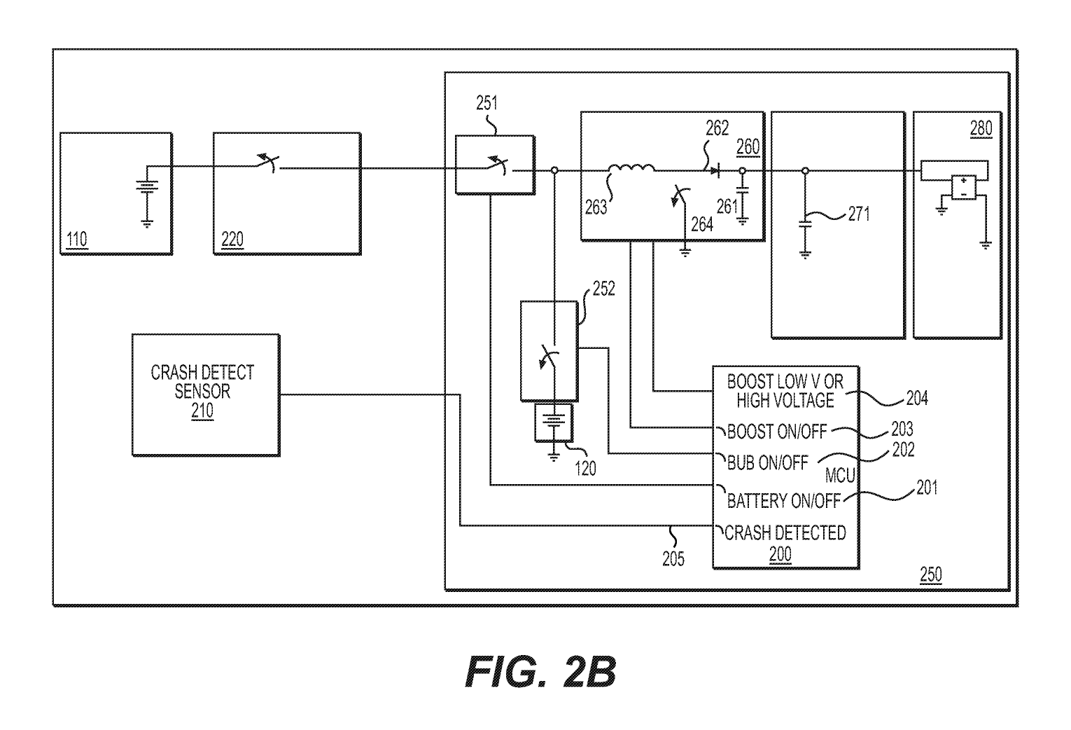

FIGS. 2(a) and (b) illustrate an example of TCU system 250 employing the aspects disclosed herein. FIG. 2(a) is a high-level system diagram of the various components, and FIG. 2(b) is a circuit-level diagram of a sample implementation of FIG. 2(a).

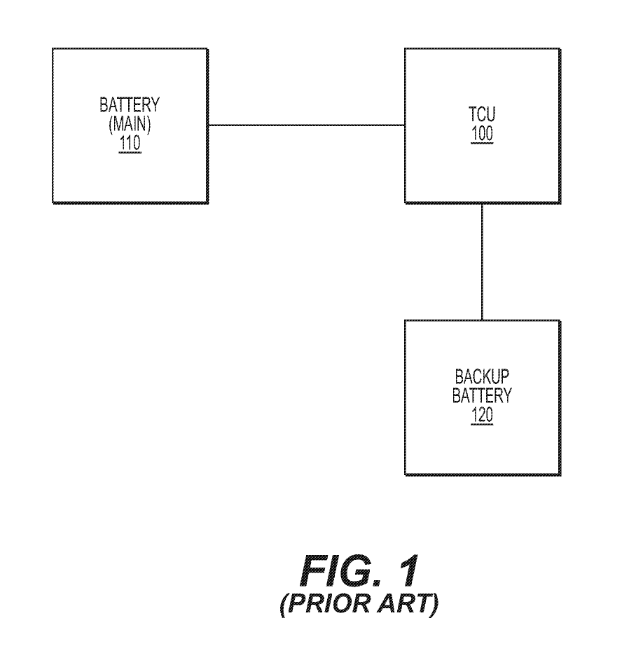

All the elements shown in FIG. 1 are incorporated into FIGS. 2(a) and (b), and thus, a description of these elements will be omitted. The BUB 120 may be integrated into the TCU 250, or separately (as shown in FIG. 1).

Also additionally shown is switch 220 (which may be a transistor, or may just represent a condition in which the main battery 110 is disconnected). Thus, the switch 220 may be controlled from a vehicle-based controller (not shown), or represent a situation in which the wire harness connecting the main battery 110 to the TCU 250 is disconnected.

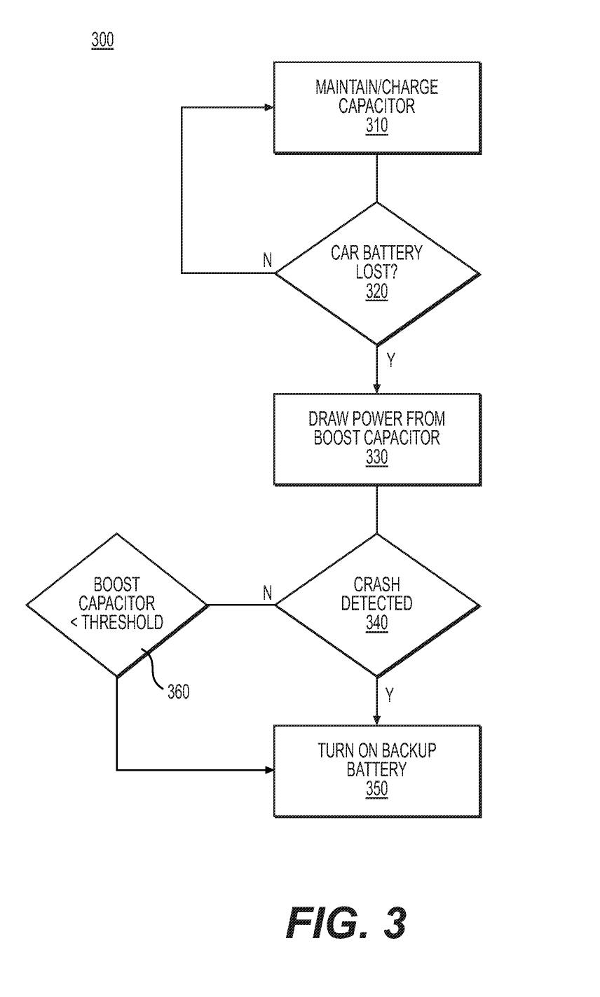

A boost logic 200 element is shown as integrated in to the TCU 250. The boost logic 200 is a microprocessor, such as those commonly provided in the art, configured with the instructions described in FIG. 3. The boost logic 200 includes input/outputs for whether the battery (is) ON/OFF 201, whether the BUB (is) ON/OFF 202, whether the boost circuit (is) ON/OFF 203, and whether the boost (circuit is) low voltage or high voltage 204. Also shown is an input from the crash detect sensor 210 (205).

The crash detect sensor 210 is an electronic sensor that determines whether the vehicle has undergone an emergency situation requiring the TCU 250 to generate an ecall. Crash detect sensor 210 may be equipped with a system to detect whether the vehicle has been in a crash, or merely just propagate an indication from another system (for example, an airbag deployment system).

Inputs/outputs 201-204 control various elements such as those shown in FIG. 2(b). The battery on/off 201 signal controls switch 251. If the switch 252 is controlled to be off, power is no longer being drawing from the main battery 110.

The BUB on/off 202 signal controls switch 252. In an off state, the BUB 120 is not connected to the TCU load 280. In an on state, the BUB 120 is connected, and is subsequently powering TCU load 280.

The TCU load 280 represents the circuits required to implement a telematics function according to those conventionally employed, and also includes control logic employed to implement an ecall system. Thus, power being delivered to the TCU load 280 is effectively employed to operate the TCU 250.

Boost on/off 203 and the boost low V/high V 204 controls the variable boost power supply 260. The variable boost power supply 260 allows the voltage being supplied to the TCU load 280 to be either at high voltage state or a low voltage state (controlled by boost low V/high V 204). Whether power is supplied from the variable boost power supply 260 is controlled by a signal generated from the boost on/off 203 input/output.

The variable boost power supply 260 allows for voltage stored from a temporary storage source (capacitor 261) to be bumped up to a voltage high enough to supply the TCU load 280. The variable boost power supply 260 includes an inductor 263, and a diode 262 connected capacitor 261, with a switch 264. The switch 264 is controlled by a boost control IC which maintains the proper boost output voltage high or low dictated by 204.

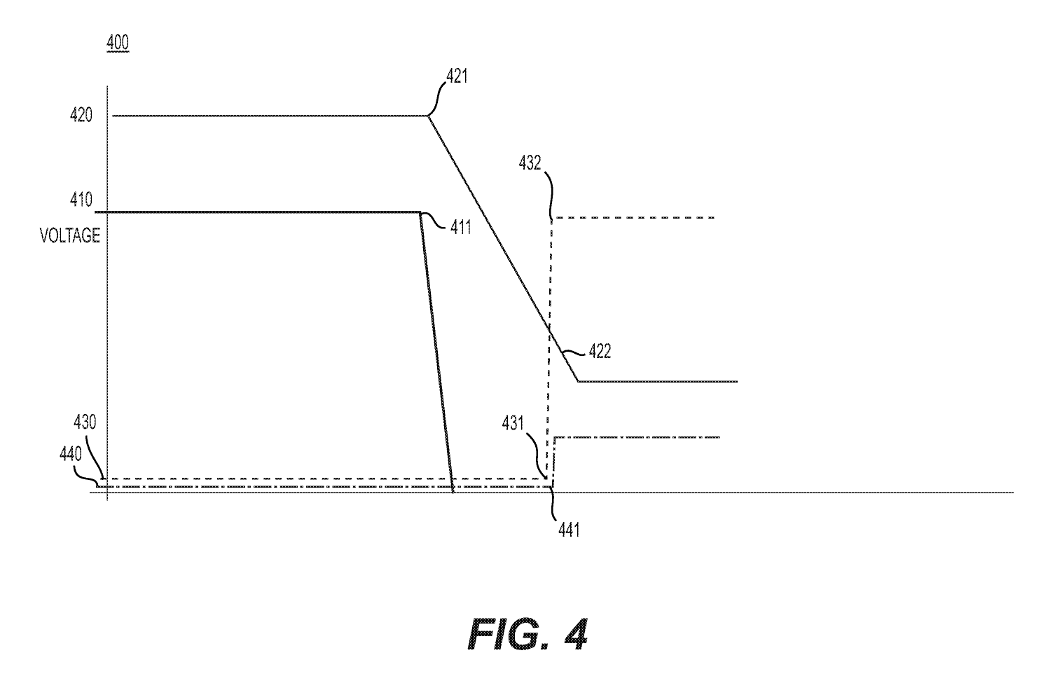

The operation of the boost logic 200, according to the aspects disclosed herein will be described with the flowchart 300 of FIG. 3, and a sample set of waveforms on the graph 400 shown in FIG. 4.

In operation 310, the capacitor 261 is charged while the TCU load 280 is being supplied power from the main battery 110. Thus, switches 220, 251 are closed, while switch 252 is open.

In graph 400, this is depicted until main battery power (or voltage) 410 transitions at point 411 from a full voltage (for example, 12 Volts) to 0 volts. Thus, no power is available from the main battery 110.

In operation 320, a determination is made as to whether power is lost (for the reasons explained above). If the determination is yes, the method 300 proceeds to operation 330. If the determination is no, the method 300 stays at the state described in operation 310.

In operation 330, power is drawn from the boost capacitor 261. In this instance, switch 220 is presumed to be open (or the main battery 110 is shut off). Switch 251 is transitioned from a state of closed to open.

In graph 400, this is depicted as boost power 420 (presumably at a full state, for example 18 volts) being drawn upon as the main battery power 410 is lost (at 421). As the temporary boost power storage 261 is drawn upon, the voltage gets reduced accordingly. The boost power supply 262 is configured in the high voltage state (for example 18v) when vehicle battery 110 is present (for example 12v) to store far greater energy in C261 per the capacitor energy equation energy=½×C×V̂2. Raising the voltage on the boost output capacitor C261 allows for much longer time that C261 can power the TCU when battery 110 is not present and the BUB has not been turned on.

In operation 340, and after a predetermined time, a determination is made as to whether a crash has been detected. If yes, the BUB 120 is employed to supply the TCU load 280 via the closing of switch 252 (operation 350). At this juncture, the variable boost power supply 260 is switched from supplying high voltage to low voltage by changing the logic state of 204 from a logic zero to one. Operating the variable boost power supply at a lower output voltage (example 6v) improves the efficiency of the boost power supply 260 and extends the time the TCU 250 can be powered by the BUB 252. Thus a variable boost power supply solves two issues. 1) For loss of battery 110 the boost high voltage state allows for longer operation of the TCU without having to draw energy from the BUB is the battery power loss is temporary (example 50 ms). 2) When the TCU must run off the BUB the boost low voltage state improves the boost efficiency and extends the time the TCU can run off the BUB.

In operation 340, if the crash detect sensor 210 communicates a crash detect occurs, the following occurs as shown in graph 400: crash detect signal 430 transitions at 431 to 432 (from a state of no indication to on). Accordingly, the BUB signal 440 is also asserted on (at 441). This may preferably occur after a predetermined time. In another implementation, the BUB 120 may only be applied to the TCU load 280 (with signal 440 being turned on), after the boost output voltage 420 reaches a predetermined level (for example, C261 voltage>Boost low voltage. This is illustrated in graph 400 at 422.

If no crash is detected, the method 300 proceeds to operation 360, with the BUB 120 not being turned on until the boost voltage drops below a specific threshold. After which, the BUB 120 is turned on (as done in operation 350) for a specified time to see if a crash occurs after battery is lost.

Thus, employing the aspects disclosed herein, a vehicle-electronics provider may implement a TCU system that is able to address temporary losses of power, while still maintaining a BUB for employment when required.

Certain of the devices shown include a computing system (for example the boost logic 200). The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 3. The disclosed devices, components, and systems contemplate using or implementing any suitable technique for performing the steps illustrated in these figures. Thus, FIG. 3 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for providing a temporary management of power for a telematics control unit (TCU) of a vehicle, comprising:
a TCU including a boost logic microprocessor coupled to a first switch that allows power from a backup battery (BUB), a crash detect sensor implemented in the vehicle, and a temporary power storage capacitor;
the boost logic microprocessor that executes the program of instructions, the instruction comprising the following steps:
in a normal operation, charging the temporary power storage capacitor,
in response to a main battery of the vehicle not supplying power to the TCU, switching the first switch that allows power from the BUB after receiving an indication of a crash from the crash detect sensor from a state of open to closed, thereby electrically coupling a load of the TCU with the BUB.

2. The system according to claim 1, further comprising:
a variable boost power supply with a second switch, the second switch being normally open and maintaining a high voltage to be stored on the temporary power storage capacitor, and
when closed, maintaining a low voltage to be stored on the temporary power storage capacitor.

3. The system according to claim 2, wherein the second switch is switched from open to closed in response to the first switch being switched from open to closed.

4. The system according to claim 1, wherein after losing power from the main battery, and in response to the temporary power storage capacitor being below a predetermined threshold, switching the first switch from open to closed.

5. The system according to claim 1, wherein after receiving the indication, switching the first switch from open to closed after a predetermined delay.

6. The system according to claim 1, wherein the TCU is coupled to an emergency call (ecall) system.
